(19) United States
(12) Patent Application Publication
(10) Pub. No.: US 2026/0269409 A1
(43) Pub. Date: Sep. 10, 2026

(54) BATTERY

(71) Applicant: HONDA MOTOR CO., LTD., Tokyo (JP)

(72) Inventors: Masataka Ohashi, Saitama (JP); Harumi Takedomi, Saitama (JP)

(73) Assignee: HONDA MOTOR CO., LTD., Tokyo (JP)

(21) Appl. No.: 19/558,510

(22) Filed: Mar. 6, 2026

(30) Foreign Application Priority Data
Mar. 10, 2025 (JP) 2025-037315

(51) Int. Cl. H01M 50/269; H01M 10/42; H01M 50/204; H01M 50/503; H01M 50/509; H01M 50/574

(52) U.S. Cl. CPC H01M 50/269; H01M 10/425; H01M 50/204; H01M 50/503; H01M 50/509; H01M 50/574; H01M 2220/20

(57) ABSTRACT

A battery has a first battery module, a second battery module, a connection switching circuit that selectively switches a connection between the first and second battery modules to a series connection or a parallel connection. The connection switching circuit includes a series switch element provided at a midpoint in a series connection of the first and second battery modules, a first parallel switch element provided in parallel with a series circuit of the first battery module and the series switch element, and a second parallel switch element provided in parallel with a series circuit of the second battery module and the series switch element. A conductive path connects the first battery module, the series switch element, and the second battery module in series in this order between input and output terminals of the connection switching circuit. The first and second parallel switch elements are disposed inside the conductive path.

### CROSS-REFERENCE TO RELATED APPLICATIONS

This application is based on and claims priority under 35 USC 119 from Japanese Patent Application No. 2025-037315 filed on Mar. 10, 2025, the entire content of which is incorporated herein by reference.

### TECHNICAL FIELD

The present disclosure relates to a battery mounted on a vehicle.

### BACKGROUND ART

In recent years, research and development have been conducted on secondary batteries that contribute to energy efficiency in order to allow more people to secure access to reliable, sustainable, and advanced energy.

The battery pack described in JP2024-115039A includes a plurality of battery modules, and a bus bar and a connection contactor that connect the plurality of battery modules. By changing the connection configuration between the battery modules due to the opening and closing control of the connection contactor, the battery pack can be charged in both the 400 V class charging facility and the 800 V class charging facility.

### SUMMARY OF INVENTION

The present disclosure provides a battery capable of reducing the size of a circuit that changes a connection configuration between a plurality of battery modules.

An aspect of the present disclosure is a battery having:

a first battery module;

a second battery module;

a connection switching circuit configured to selectively switch a connection between the first battery module and the second battery module to a series connection or a parallel connection, in which

the connection switching circuit includes:

a series switch element provided at a midpoint in a series connection of the first battery module and the second battery module;

a first parallel switch element provided in parallel with a series circuit of the first battery module and the series switch element; and

a second parallel switch element provided in parallel with a series circuit of the second battery module and the series switch element,

a conductive path, which connects the first battery module, the series switch element, and the second battery module in series in this order between input and output terminals of the connection switching circuit, is formed in a U shape, and

the first parallel switch element and the second parallel switch element are disposed inside the conductive path.

According to the aspect of the present disclosure, it is possible to reduce the size of the circuit that changes the connection configuration between the plurality of battery modules.

### BRIEF DESCRIPTION OF DRAWINGS

Exemplary embodiment(s) of the present invention will be described in detail based on the following figures, wherein:

FIG. 1 is a diagram showing an example of a charging system including a battery for illustrating an embodiment of the present disclosure;

FIG. 2 shows a first voltage state of the battery of FIG. 1;

FIG. 3 shows a second voltage state of the battery of FIG. 1;

FIG. 4 is an actual wiring diagram of an example of a connection switching circuit of the battery of FIG. 1;

FIG. 5 is a circuit diagram of the connection switching circuit of FIG. 4;

FIG. 6 shows a current path when the battery is in the first voltage state, in the actual wiring diagram of the connection switching circuit of FIG. 4;

FIG. 7 shows a current path when the battery is in the first voltage state, in the circuit diagram of the connection switching circuit of FIG. 5;

FIG. 8 is a diagram showing a current path passing through the first battery module when the battery is in the second voltage state, in the actual wiring diagram of the connection switching circuit of FIG. 4;

FIG. 9 is a diagram showing a current path passing through the second battery module when the battery is in the second voltage state, in the actual wiring diagram of the connection switching circuit of FIG. 4;

FIG. 10 shows a current path when the battery is in the second voltage state, in the circuit diagram of the connection switching circuit of FIG. 5; and

FIG. 11 is an actual wiring diagram of a modification of the connection switching circuit of FIG. 4.

### DESCRIPTION OF EMBODIMENTS

An example of a charging system including a battery for explaining an embodiment of the present disclosure will be described with reference to the accompanying drawings.

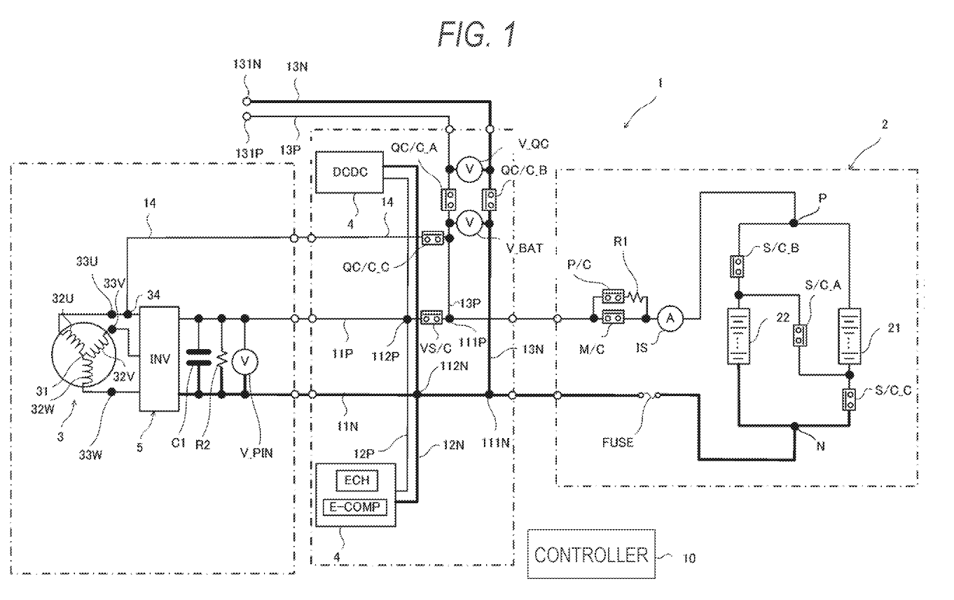

A charging system 1 shown in FIG. 1 is mounted on an electric vehicle such as an electric automobile. The electric vehicle equipped with the charging system 1 corresponds to charging facilities of 400 V class and 800 V class, and can not only rapidly charge the battery 2 at charging voltages of 400 V and 800 V but also drive the three-phase motor 3 and the auxiliary device 4 at a base voltage of 800 V. Note that the auxiliary device 4 can be driven even if the voltage is not necessarily 800 V.

As shown in FIG. 1, the charging system 1 includes a battery 2, a three-phase motor 3, an auxiliary device 4, an inverter 5 (PDU), electric power supply circuits 11P and 11N, auxiliary device drive circuits 12P and 12N, DC power supply circuits 13P and 13N, a branch circuit 14, and a controller 10.

As shown in FIGS. 1 to 3, the battery 2 includes a first battery module 21, a second battery module 22, first to fifth contactors M/C, S/C_A, S/C_B, S/C_C, P/C, a first resistor R1, a current sensor IS, and a current breaker FUSE. Each of the first battery module 21 and the second battery module 22 is a battery module capable of charging and discharging 400 V.

The first contactor M/C is disposed at the end on the positive electrode side of the battery 2, and functions as a main switch that turns on/off the connection of the battery 2 to the outside (the electric power supply circuit 11P).

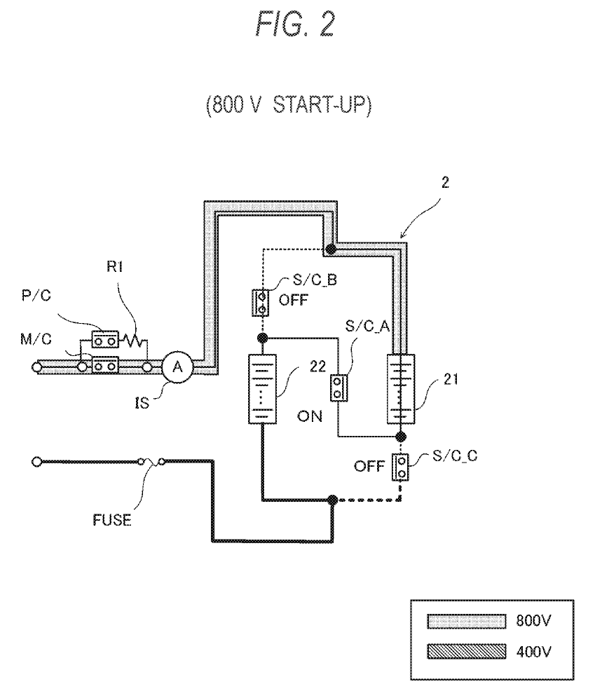

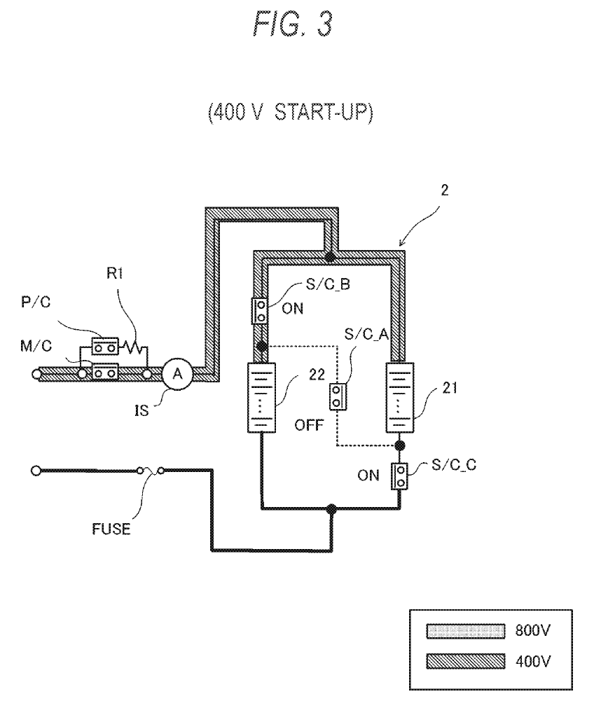

The second to fourth contactors S/C_A, S/C_B, and S/C_C switch the connection state between the first battery module 21 and the second battery module 22. For example, as shown in FIG. 2, when the second contactor S/C_A is turned on, and the third contactor S/C_B and the fourth contactor S/C_C are turned off, the battery 2 becomes a first voltage state (800 V activation) in which the first battery module 21 and the second battery module 22 are connected in series, and charging and discharging in the 800 V become possible. Further, as shown in FIG. 3, when the second contactor S/C_A is turned off and the third contactor S/C_B and the fourth contactor S/C_C are turned on, the battery 2 becomes the second voltage state (400 V activation) in which the first battery module 21 and the second battery module 22 are connected in parallel, and charging and discharging in the 400 V become possible. The term “start” is a concept including driving of an electric vehicle equipped with the charging system 1 during traveling and charging of the electric vehicle during parking.

The fifth contactor P/C and the first resistor R1 are arranged in series, and are arranged in parallel with the first contactor M/C. The fifth contactor P/C is turned on before the first contactor M/C is turned on in the first voltage state and the second voltage state, thereby protecting the first contactor M/C from an excessive inrush current.

The current sensor IS is disposed between the first contactor M/C and the battery module 21, 22 and measures a current.

The current breaker FUSE is disposed at the end on the negative electrode side of the battery 2, and cuts off the connection of the battery 2 to the outside (the electric power supply circuit 11N) when an abnormality occurs. In the charging system 1 of the present embodiment, the current breaker FUSE is configured by a pyro-fuse capable of intentionally cutting off a current according to an electric signal, and when an abnormality occurs (a collision of the vehicle, a short circuit in the battery 2, or the like), the current breaker FUSE is operated to cut off, and all the contactors in the battery 2 are turned off (opened).

The three-phase motor 3 includes three-phase coils 32U, 32V, and 32W, one ends of which are connected to a neutral point 31, and is rotationally driven by electric power supplied from the battery 2 via the inverter 5. The three-phase motor 3 of the present embodiment includes a U-phase terminal 33U, a V-phase terminal 33V, and a W-phase terminal 33W connected to the other end sides of the coils 32U, 32V, and 32W. The U-phase terminal 33U, the V-phase terminal 33V, and the W-phase terminal 33W are connected to the inverter 5. The other end side of any one of the coils 32U, 32V, and 32W of one phase is connected to the branch circuit 14 at a connection portion 34. In the present embodiment, among the three-phase coils 32U, 32V, and 32W, the coil 32U is connected to the branch circuit 14 at the connection portion 34 located between the U-phase terminal 33U and the inverter 5.

The inverter 5 converts the DC power supplied from the battery 2 into three-phase AC power by switching the plurality of switching elements to rotationally drive the three-phase motor 3. When the DC current (400 V) is supplied from the branch circuit 14 to the connection unit 34, the inverter 5 can function as a booster circuit (DC voltage conversion unit) that boosts the DC current by using the coil connected to the branch circuit 14 and the other one-phase or two-phase coil by switching the plurality of switching elements.

The auxiliary device 4 is an in-vehicle device that can be driven by DC power from the battery 2 and an external power supply, and includes, for example, an electric compressor E-COMP for an air conditioner (A/C), an electric heater ECH, an auxiliary converter DCDC, and the like. The electric compressor E-COMP and the electric heater ECH are high-voltage drive in-vehicle devices, and the auxiliary device converter DCDC steps down the DC power from the battery 2 and the external power supply to drive the low-voltage drive in-vehicle devices. The auxiliary device 4 is connected to the battery 2 via the auxiliary device drive circuits 12P and 12N, the sixth contactor VS/C, and the electric power supply circuits 11P and 11N. The auxiliary device 4 of the present embodiment is operated at a base voltage of 800 V while the vehicle is traveling. On the other hand, the auxiliary device 4 can operate even if the voltage is not necessarily 800 V, and is configured to operate by being boosted to an efficient drive voltage at the time of charging of 400 V.

The electric power supply circuits 11P and 11N are configured as a pair of positive and negative, and connect the battery 2 and the inverter 5 (the three-phase motor 3). The electric power supply circuits 11P and 11N are provided with connection portions 111P and 111N to the DC power supply circuits 13P and 13N, and connection portions 112P and 112N to the auxiliary machine drive circuits 12P and 12N (the auxiliary machine 4) are provided closer to the inverter 5 than the connection portions 111P and 111N. Further, the electric power supply circuit 11P on the positive electrode side is provided with the sixth contactor VS/C that turns on/off the circuit between the connection portion 112P with the auxiliary machine drive circuit 12P and the connection portion 111P of the DC power supply circuit 13P. A first voltage sensor V_PIN, a first smoothing capacitor C1, and a second resistor R2 are provided on the inverter 5 side of the electric power supply circuits 11P and 11N. The first voltage sensor V_PIN, the first smoothing capacitor C1, and the second resistor R2 are provided on a circuit connecting the electric power supply circuit 11P on the positive electrode side and the electric power supply circuit 11N on the negative electrode side. The second resistor R2 is provided to discharge the first smoothing capacitor C1 when the circuit is disconnected.

The DC power supply circuits 13P and 13N are configured as a pair of positive and negative circuits, charging terminals 131P and 131N to which an external power supply such as a charging facility can be connected are provided at one end, and the other end is connected to the electric power supply circuits 11P and 11N via the connection portions 111P and 111N. The DC power supply circuits 13P and 13N are provided with a seventh contactor QC/C_A and an eighth contactor QC/C_B that turn on/off the respective circuits. Further, a second voltage sensor V_BAT is provided at a position closer to the connection portions 111P and 111N than the seventh contactor QC/C_A and the eighth contactor QC/C_B. Further, a third voltage sensor V_QC is provided at a position closer to the charging terminals 131P and 131N than the seventh contactor QC/C_A and the eighth contactor QC/C_B.

The branch circuit 14 is branched at a position closer to the connection portion 111P than the eighth contactor QC/C_A and the second voltage sensor V_BAT in the DC power supply circuit 13P on the positive electrode side, and is connected to any coil of the three-phase motor 3 via the connection portion 34. A ninth contactor QC/C that turns on/off the circuit is provided in an intermediate portion of the branch circuit 14.

The controller 10 is, for example, a vehicle ECU, and controls driving and charging of the charging system 1. More specifically, the controller 10 performs ON/OFF control of each contactor M/C, S/C_A, S/C_B, S/C_C, P/C, VS/C, QC/C_A, QC/C_B, and QC/C_C, detection of welding thereof, control of the inverter 5, and the like.

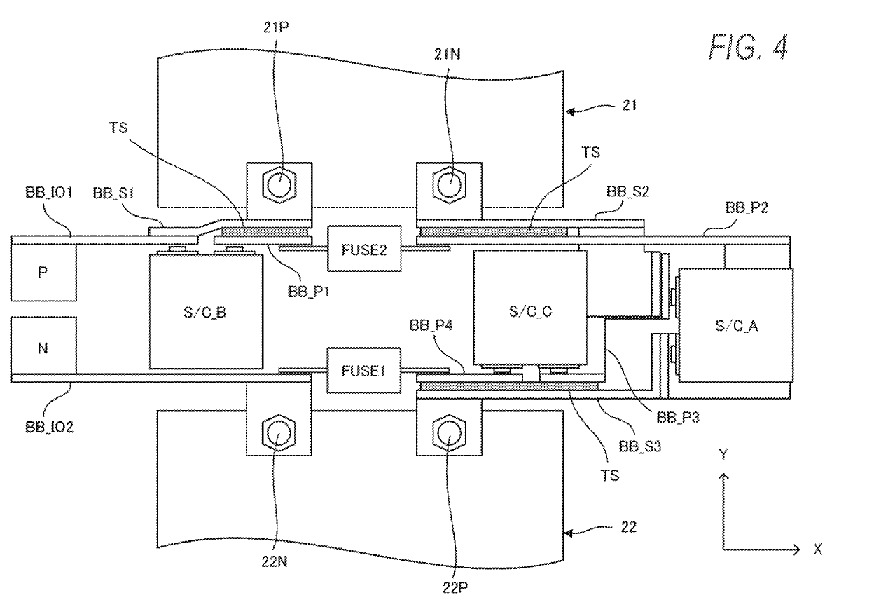

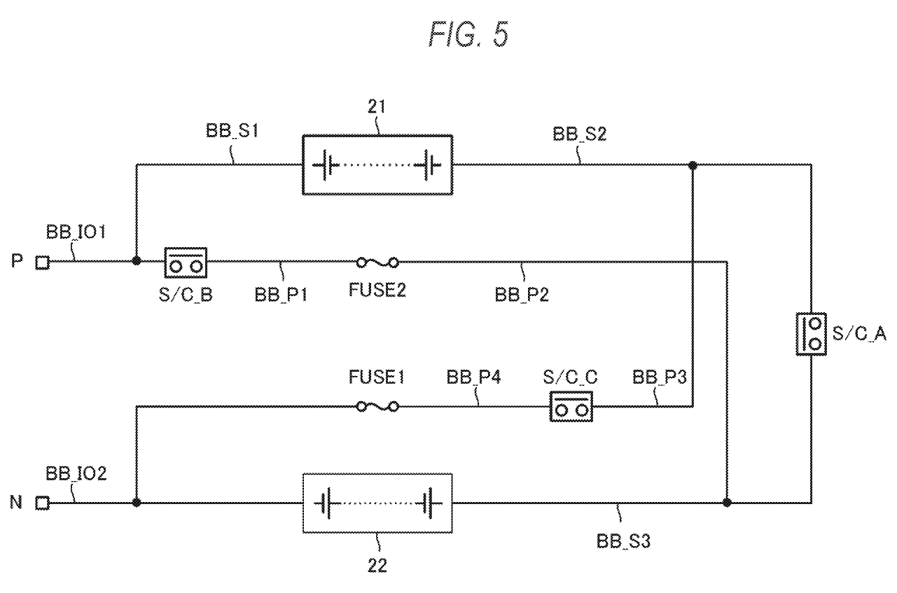

FIG. 4 is an actual wiring diagram of the connection switching circuit, and FIG. 5 is a circuit diagram of the connection switching circuit of FIG. 4.

The connection switching circuit, which switches the battery 2 between 800 V activation and 400 V activation, includes the second to fourth contactors S/C_A, S/C_B, and S/C_C and a plurality of bus bars BB, and further includes current breakers FUSE1 and FUSE2 in the example shown in FIGS. 4 and 5. Each bus bar is provided with tabs used for connection with the first battery module 21, the second battery module 22, the second to fourth contactors S/C_A, S/C_B, S/C_C, and the like.

The first battery module 21 and the second battery module 22 are disposed at an interval in a first direction (hereinafter, referred to as a Y direction), and terminal portions 21P and 21N of the first battery module 21 and terminal portions 22P and 22N of the second battery module 22 are adjacent to each other in the Y direction. The second to fourth contactors S/C_A, S/C_B, and S/C_C are arranged in a row in a second direction (hereinafter referred to as the X direction) orthogonal to the Y direction, and are disposed above between the first battery module 21 and the second battery module 22. Input/output bus bars BB_IO1 and BB_IO2 are arranged on one end side of the arrangement of the second to fourth contactors S/C_A, S/C_B, and S/C_C. The input/output bus bar BB_IO1 has a positive electrode-side tab P connected to the electric power supply circuit 11P on the positive electrode side, and the input/output bus bar BB_IO2 has a negative electrode-side tab N connected to the electric power supply circuit 11N on the negative electrode side.

The second contactor S/C_A is provided at a midpoint in the series connection of the first battery module 21 and the second battery module 22, and can connect the first battery module 21 and the second battery module 22 in series. The plurality of bus bars BB include series bus bars BB_S1, BB_S2, and BB_S3 that connect the first battery module 21, the second contactor S/C_A, and the second battery module 22 in series in this order between the input/output bus bars BB_IO1 and BB_IO2.

The series bus bar BB_S1 connects a tab of the input/output bus bar BB_IO1 opposite to the positive electrode-side tab P and the terminal portion 21P of the first battery module 21. The series bus bar BB_S2 connects the terminal portion 21N of the first battery module 21 and one terminal portion of the second contactor S/C_A. The series bus bar BB_S3 connects the other terminal portion of the second contactor S/C_A and the terminal portion 22P of the second battery module 22. The terminal portion 22N of the second battery module 22 is directly connected to the tab of the input/output bus bar BB_IO2 on the side opposite to the negative electrode-side tab N.

The first battery module 21, the second battery module 22, the second contactor S/C_A, the input/output bus bars BB_IO1 and BB_IO2, and the series bus bars BB_S1, BB_S2, and BB_S3 form a U-shaped conductive path, as a whole, folded back at the second contactor S/C_A. The series bus bars BB_S1 and BB_S2 forming the conductive path from the input/output bus bar BB_IO1 to the second contactor S/C_A via the first battery module 21 extend in the X direction, and the series bus bar BB_S3 forming the conductive path from the second contactor S/C_A to the input/output bus bar BB_IO2 via the second battery module 22 also extends in the X direction. Portions extending in the X direction of each of the series bus bars BB_S1, BB_S2, and BB_S3 are disposed such that the plate surface having a relatively large area faces the Y direction.

The third contactor S/C_B and the fourth contactor S/C_C are arranged inside a U-shaped conductive path including the first battery module 21, the second battery module 22, and the second contactor S/C_A, and are arranged in the order of the third contactor S/C_B, the fourth contactor S/C_C, and the second contactor S/C_A from the side of the input/output bus bars BB_IO1 and BB_IO2.

The third contactor S/C_B is provided in parallel with the series circuit of the first battery module 21 and the second contactor S/C_A. The third contactor S/C_B bypasses the first battery module 21 and the second contactor S/C_A, and can connect the second battery module 22 to the input/output bus bars BB_IO1 and BB_IO2. The plurality of bus bars BB further include first parallel bus bars BB_P1 and BB_P2 that connect the third contactor S/C_B in parallel with the series circuit of the first battery module 21 and the second contactor S/C_A.

One terminal portion of the third contactor S/C_B is directly connected to a tab of the input/output bus bar BB_IO1 on a side opposite to the positive electrode-side tab P. The first parallel bus bars BB_P1 and BB_P2 are connected to each other via the current breaker FUSE2, and connect the other terminal portion of the third contactor S/C_B and the series bus bar BB_S3. The current breaker FUSE2 is connected in series to the third contactor S/C_B, and is provided in parallel with the series circuit of the first battery module 21 and the second contactor S/C_A together with the third contactor S/C_B.

The first parallel bus bars BB_P1 and BB_P2 extend in the X direction in parallel with the series bus bars BB_S1 and BB_S2 forming a conductive path from the input/output bus bar BB_IO1 to the second contactor S/C_A via the first battery module 21. Similarly to the series bus bars BB_S1 and BB_S2, the portions of the first parallel bus bars BB_P1 and BB_P2 extending in the X direction are arranged such that the plate surfaces having a relatively large area face in the Y direction.

An insulating thermally conductive sheet TS is sandwiched between the first parallel bus bars BB_P1 and BB_P2 and the series bus bars BB_S1 and BB_S2 facing each other in the Y direction. The first parallel bus bars BB_P1 and BB_P2 and the series bus bars BB_S1 and BB_S2 overlap each other while maintaining electrical insulation and are thermally coupled by the interposed heat conductive sheet TS. The insulating thermally conductive sheet TS is, for example, a silicone sheet filled with a thermally conductive filler.

The fourth contactor S/C_C is provided in parallel with the series circuit of the second contactor S/C_A and the second battery module 22. The fourth contactor S/C bypasses the second contactor S/C_A and the second battery module 22, and can connect the first battery module 21 to the input/output bus bars BB_IO1 and BB_IO2. The plurality of bus bars BB further include second parallel bus bars BB_P3 and BB_P4 that connect the fourth contactor S/C_C in parallel with the series circuit of the second contactor S/C_A and the second battery module 22.

One tab of the second parallel bus bar BB_P3 is connected to the series bus bar BB_S2, and the other tab of the second parallel bus bar BB_P3 is connected to one terminal portion of the fourth contactor S/C_C. The other terminal portion of the fourth contactor S/C_C is connected to the input/output bus bar BB_IO2 via the second parallel bus bar BB_P4 and the current breaker FUSE1. The current breaker FUSE1 is connected in series to the fourth contactor S/C_C, and is provided in parallel with the series circuit of the second battery module 22 and the second contactor S/C_A together with the fourth contactor S/C_C.

The second parallel bus bars BB_P3 and BB_P4 extend in the X direction in parallel with the series bus bar BB_S3 forming a conductive path from the second contactor S/C_A to the input/output bus bar BB_IO2 via the second battery module 22. The portions of the second parallel bus bars BB_P3 and BB_P4 extending in the X direction are arranged such that the plate surfaces having a relatively large area face in the Y direction, similarly to the series bus bar BB_S3.

The insulating thermally conductive sheet TS is sandwiched between the second parallel bus bars BB_P3 and BB_P4 and the series bus bar BB_S3 facing each other in the Y direction. The second parallel bus bars BB_P3 and BB_P4 and the series bus bar BB_S3 overlap each other while maintaining electrical insulation and are thermally coupled by the interposed heat conductive sheet TS.

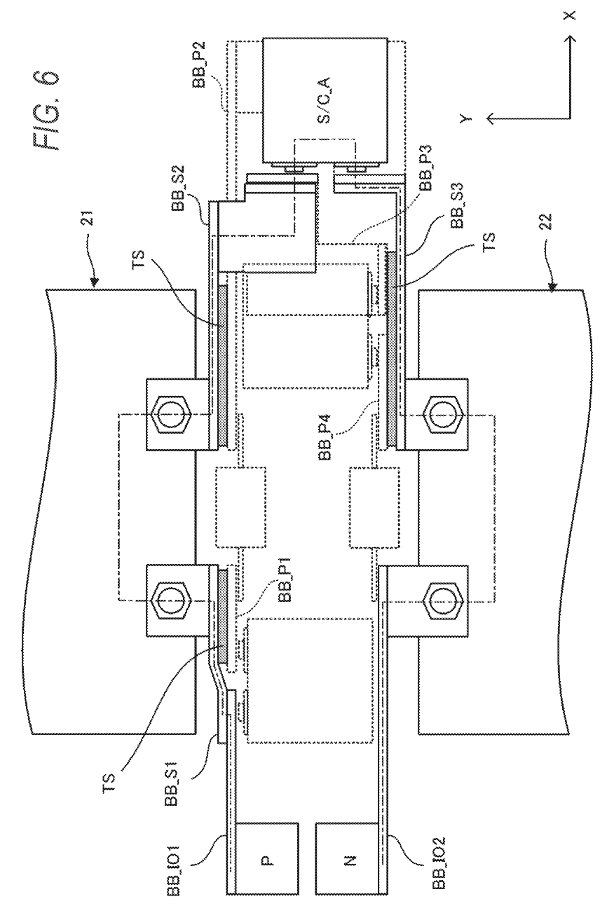

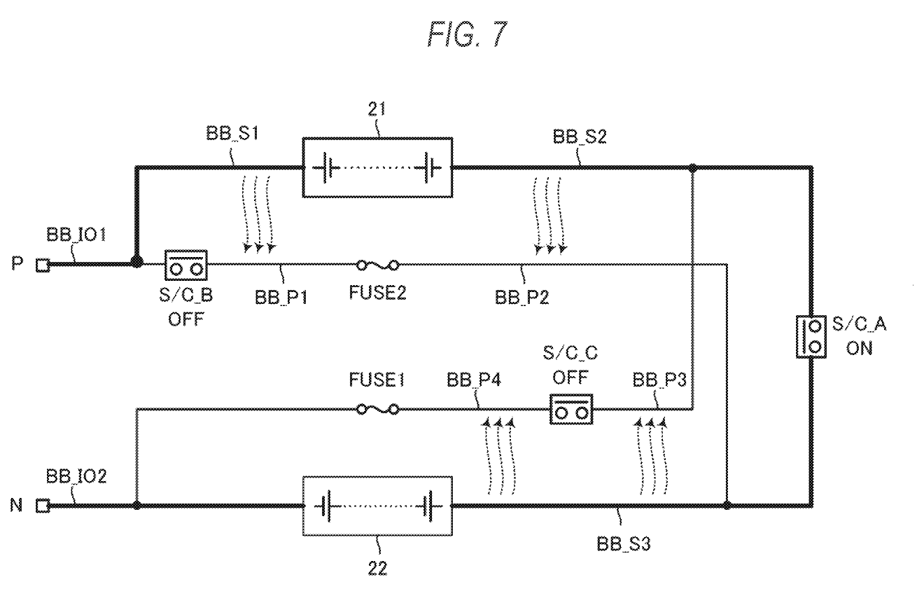

FIG. 6 shows a current path in the 800 V activation state, in the actual wiring diagram of the connection switching circuit of FIG. 4. FIG. 7 shows a current path in the 800 V startup state in the circuit diagram of the connection switching circuit of FIG. 5.

When the second contactor S/C_A is set to ON and the third contactor S/C_B and the fourth contactor S/C_C are set to OFF, the first battery module 21 and the second battery module 22 are connected in series, and the battery 2 becomes a 800 V startup state.

As illustrated in FIGS. 6 and 7, when the battery 2 is in the 800 V activation state, the current flows through the series bus bars BB_S1, BB_S2, and BB_S3. The series bus bars BB_S1, BB_S2, and BB_S3 generate heat as they are energized. On the other hand, no current flows through the first parallel bus bars BB_P1 and BB_P2 and the second parallel bus bars BB_P3 and BB_P4, and no heat is generated in the first parallel bus bars BB_P1 and BB_P2 and the second parallel bus bars BB_P3 and BB_P4. The heat generated in the series bus bars BB_S1, BB_S2, and BB_S3 is dissipated to the atmosphere from the surfaces of the series bus bars BB_S1, BB_S2, and BB_S3, is diffused to the first parallel bus bars BB_P1 and BB_P2 and the second parallel bus bars BB_P3 and BB_P4 via the heat conductive sheet TS, and is dissipated to the atmosphere from the surfaces of the first parallel bus bars BB_P1 and BB_P2 and the second parallel bus bars BB_P3 and BB_P4.

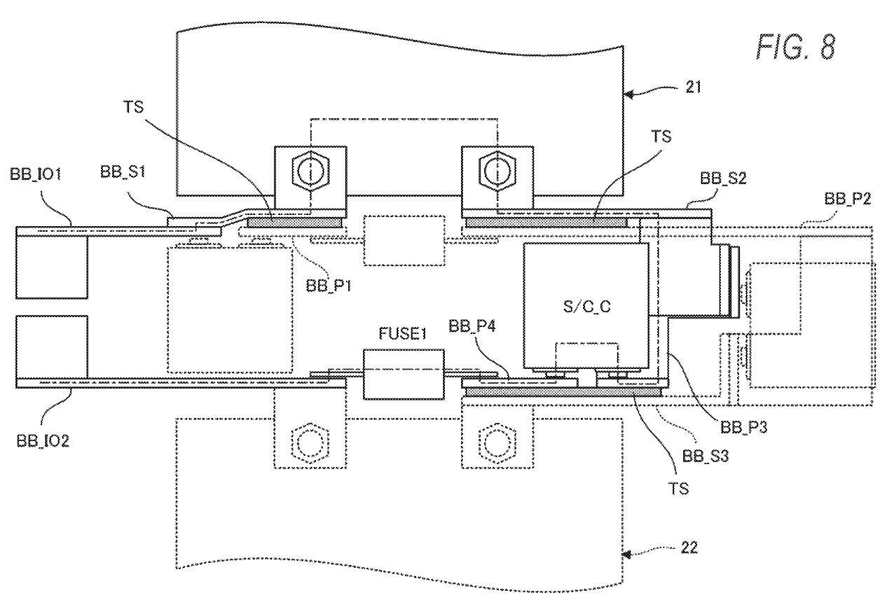

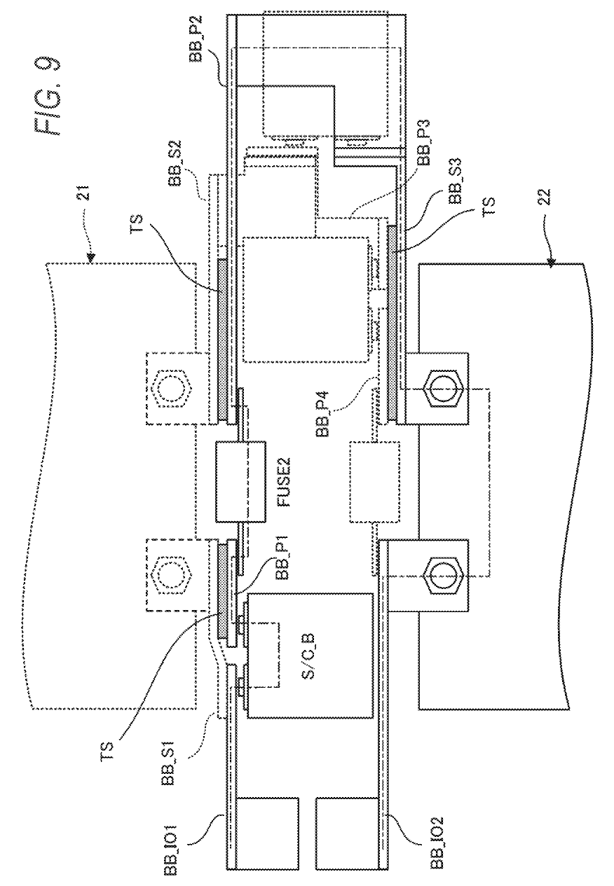

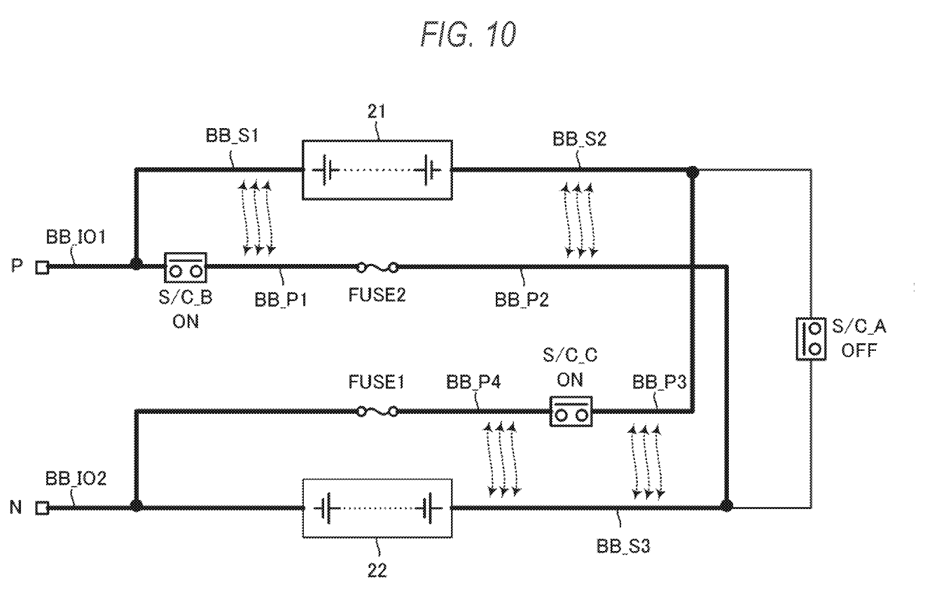

FIGS. 8 and 9 illustrate current paths in the 400 V activation state in the actual wiring diagram of the connection switching circuit of FIG. 4. FIG. 10 shows a current path in the 400 V startup state in the circuit diagram of the connection switching circuit of FIG. 5.

When the second contactor S/C_A is set to OFF and the third contactor S/C_B and the fourth contactor S/C_C are set to ON, the first battery module 21 and the second battery module 22 are connected in parallel, and the battery 2 becomes the second voltage state (400 V activation).

As illustrated in FIGS. 8 to 10, when the battery 2 is in the 400 V activation state, the current flowing through the first battery module 21 flows through the series bus bars BB_S1 and BB_S2, the second parallel bus bars BB_P3 and BB_P4, and the current breaker FUSE1. The series bus bars BB_S1 and BB_S2 and the second parallel bus bars BB_P3 and BB_P4 generate heat as they are energized. The current flowing through the second battery module 22 flows through the first parallel bus bars BB_P1 and BB_P2, the series bus bar BB_S3, and the current breaker FUSE2. The first parallel bus bars BB_P1 and BB_P2 and the series bus bar BB_S3 generate heat as they are energized.

The heat generated in the first parallel bus bars BB_P1 and BB_P2 and the series bus bars BB_S1 and BB_S2 overlapping each other via the heat conductive sheet TS moves between these bus bars via the heat conductive sheet TS so as to reduce the temperature gradient between the bus bars. Similarly, the heat generated in the second parallel bus bars BB_P3 and BB_P4 and the series bus bar BB_S3 overlapping each other via the heat conductive sheet TS moves between these bus bars via the heat conductive sheet TS so as to reduce the temperature gradient between the bus bars. Then, the heat is dissipated to the atmosphere from the surfaces of the first parallel bus bars BB_P1 and BB_P2, the second parallel bus bars BB_P3 and BB_P4, and the series bus bars BB_S1, BB_S2, and BB_S3.

Here, when an abnormality occurs in one of the first battery module 21 and the second battery module 22, the current breakers FUSE1 and FUSE2 function to disconnect the battery module in which the abnormality has occurred from the connection switching circuit. That is, when an abnormality occurs in the first battery module 21, the current breaker FUSE1 included in the path of the current flowing through the first battery module 21 cuts off this current path. On the other hand, when an abnormality occurs in the second battery module 22, the current breaker FUSE2 included in the path of the current flowing through the second battery module 22 cuts off this current path. As a result, power supply to the three-phase motor 3 and the like is continued by the other battery module, and it is possible to travel to, for example, a safe place. The current breakers FUSE1 and FUSE2 are, for example, pyro-fuses capable of intentionally cutting off a current according to an electric signal.

The current breakers FUSE1 and FUSE2 are disposed inside the U-shaped conductive path including the first battery module 21, the second battery module 22, and the second contactor S/C_A, are adjacent to each other in the Y direction, and are disposed between the third contactor S/C_B and the fourth contactor S/C_C. That is, the third contactor S/C_B, the current breakers FUSE1 and FUSE2, the fourth contactor S/C_C, and the second contactor S/C_A are arranged in this order from the input/output bus bars BB_IO1 and BB_IO2 side.

As described above, by disposing the third contactor S/C_B inside the U-shaped conductive path formed of the series bus bars BB_S1, BB_S2, BB_S3 and the second contactor S/C_A that connect the first battery module 21 and the second battery module 22 in series, it is possible to efficiently arrange the first parallel bus bars BB_P1, BB_P2 for bypassing the first battery module 21 and the second contactor S/C_A. Similarly, by disposing the fourth contactor S/C inside the U-shaped conductive path formed by the series bus bars BB_S1, BB_S2, BB_S3 and the second contactor S/C_A, it is possible to efficiently arrange the second battery module 22 and the second parallel bus bars BB_P3, BB_P4 for bypassing the second contactor S/C_A. It is thus possible to reduce the size and cost of the connection switching circuit.

Preferably, the U-shaped conductive path formed from the series bus bars BB_S1, BB_S2, BB_S3 and the second contactor S/C_A is folded back at the second contactor S/C_A, and the second contactor S/C_A, the third contactor S/C_B and the fourth contactor S/C_C are arranged in a row. Accordingly, the connection switching circuit is miniaturized in the direction (Y direction) orthogonal to the arrangement direction (X direction) of the second contactor S/C_A, the third contactor S/C_B, and the fourth contactor S/C_C. The first battery module 21 and the second battery module 22 can be disposed close to each other, and the entire battery can be downsized.

When the current breakers FUSE1 and FUSE2 for disconnecting the battery module in which the abnormality has occurred from the connection switching circuit are provided in the connection switching circuit, the current breakers FUSE1 and FUSE2 are also preferably disposed inside the U-shaped conductive path. Accordingly, it is possible to efficiently arrange the first parallel bus bars BB_P1 and BB_P2 for bypassing the first battery module 21 and the second contactor S/C_A, and it is possible to efficiently arrange the second parallel bus bars BB_P3 and BB_P4 for bypassing the second battery module 22 and the second contactor S/C_A.

Preferably, the current breakers FUSE1 and FUSE2 are arranged between the third contactor S/C_B and the fourth contactor S/C in the arrangement of the second contactor S/C_A, the third contactor S/C_B, and the fourth contactor S/C_C. Accordingly, the connection switching circuit is miniaturized in the direction (Y direction) orthogonal to the arrangement direction (X direction) of the second contactor S/C_A, the third contactor S/C_B, and the fourth contactor S/C_C. The first battery module 21 and the second battery module 22 can be disposed close to each other, and the entire battery can be downsized.

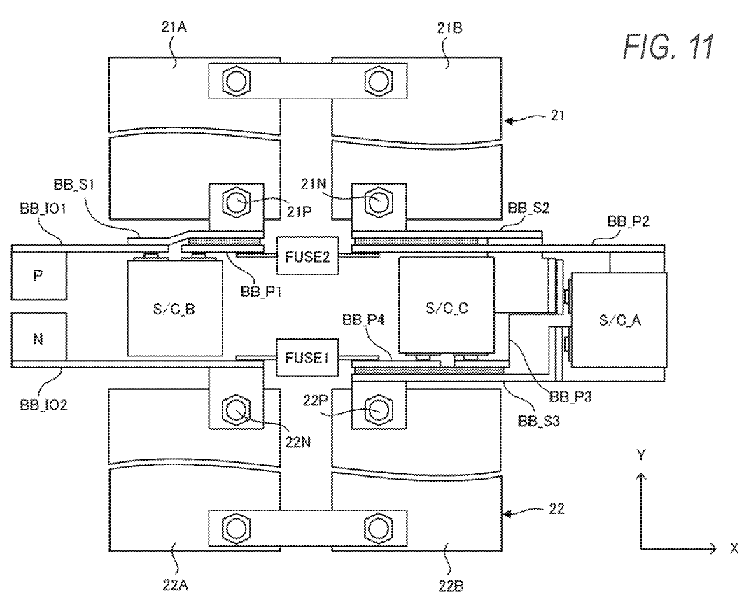

Each of the first battery module 21 and the second battery module 22 may be configured by connecting a plurality of subsidiary modules in series and/or in parallel. In the example shown in FIG. 11, the first battery module 21 is configured by connecting two subsidiary modules 21A and 21B having a nominal voltage of 200 V in series, and the second battery module 22 is also configured by connecting two subsidiary modules 22A and 22B having a nominal voltage of 200 V in series.

Although the embodiment of the present disclosure has been described above, the present invention is not limited to the above-described embodiment, and modifications, improvements, and the like can be made as appropriate. At least the following matters are described in the present specification. Although the corresponding components and the like in the above-described embodiment are shown in parentheses, the present invention is not limited thereto.

(1) A battery having:

a first battery module (first battery module 21);

a second battery module (second battery module 22); and

a connection switching circuit configured to selectively switch a connection between the first battery module and the second battery module to a series connection or a parallel connection, in which

the connection switching circuit includes:

a series switch element (second contactor S/C_A) provided at a midpoint in a series connection of the first battery module and the second battery module;

a first parallel switch element (third contactor S/C_B) provided in parallel with a series circuit of the first battery module and the series switch element; and

a second parallel switch element (fourth contactor S/C_C) provided in parallel with a series circuit of the second battery module and the series switch element,

a conductive path, which connects the first battery module, the series switch element, and the second battery module in series in this order between input and output terminals (P, N) of the connection switching circuit, is formed in a U shape, and

the first parallel switch element and the second parallel switch element are disposed inside the conductive path.

According to the battery in the above (1), it is possible to efficiently arrange the conductive path that bypasses the first battery module and the series switch element and connects the second battery module between the input and output terminals of the connection switching circuit, and the conductive path that bypasses the second battery module and the series switch and connects the first battery module between the input and output terminals of the connection switching circuit. It is thus possible to reduce the size and cost of the connection switching circuit.

(2) The battery according to the above (1), in which

the conductive path is folded back in a U shape at the series switch element, and

the series switch element, the first parallel switch element, and the second parallel switch element are arranged in a row.

According to the battery in the above (2), it is possible to reduce the size of the connection switching circuit in the direction orthogonal to the arrangement direction of the series switch element, the first parallel switch element, and the second parallel switch element. The first battery module and the second battery module can be disposed close to each other, and the entire battery can be downsized.

(3) The battery according to the above (1), in which

the connection switching circuit further includes:

a first current breaker (FUSE1) that is a circuit breaker element connected in series with the first parallel switch element, and is provided in parallel with the series circuit of the first battery module and the series switch element together with the first parallel switch element; and

a second current breaker (FUSE2) that is a circuit breaker element connected in series with the second parallel switch element, and is provided in parallel with the series circuit of the second battery module and the series switch element together with the second parallel switch element, and

the first current breaker and the second current breaker are disposed inside the conductive path.

According to the battery in the above (3), when an abnormality occurs in the first battery module, the first battery module can be disconnected from the connection switching circuit by the second current breaker, and when an abnormality occurs in the second battery module, the second battery module can be disconnected from the connection switching circuit by the first current breaker. By disposing the first current breaker and the second current breaker inside the U-shaped conductive path, it is possible to efficiently arrange the conductive path that bypasses the first battery module and the series switch element and connects the second battery module between the input and output terminals of the connection switching circuit, and the conductive path that bypasses the second battery module and the series switch and connects the first battery module between the input and output terminals of the connection switching circuit. It is thus possible to reduce the size and cost of the connection switching circuit.

(4) The battery according to the above (3), in which

the conductive path is folded back in a U-shape at the series switch element,

the series switch element, the first parallel switch element, and the second parallel switch element are arranged in a row in a first direction, and

the first current breaker and the second current breaker are adjacent to each other in a second direction orthogonal to the first direction, and are disposed between the first parallel switch element and the second parallel switch element in the first direction.

According to the battery in the above (4), it is possible to reduce the size of the connection switching circuit in the direction orthogonal to the arrangement direction of the series switch element, the first parallel switch element, the second parallel switch element, and the first current breaker and the second current breaker. The first battery module and the second battery module can be disposed close to each other, and the entire battery can be downsized.

(5) The battery according to any one of the above (1) to (4), in which

the first battery module includes a plurality of subsidiary modules (subsidiary modules 21A and 21B) connected in series and/or in parallel, and

the second battery module includes a plurality of subsidiary modules (subsidiary modules 22A and 22B) connected in series and/or in parallel.

According to the battery in the above (5), it is possible to increase the degree of freedom in setting the voltage and the capacity of the first battery module and the second battery module.

What is claimed is:

1. A battery comprising:
a first battery module;
a second battery module;
a connection switching circuit configured to selectively switch a connection between the first battery module and the second battery module to a series connection or a parallel connection, wherein
the connection switching circuit includes:
a series switch element provided at a midpoint in a series connection of the first battery module and the second battery module;
a first parallel switch element provided in parallel with a series circuit of the first battery module and the series switch element; and
a second parallel switch element provided in parallel with a series circuit of the second battery module and the series switch element,
a conductive path, which connects the first battery module, the series switch element, and the second battery module in series in this order between input and output terminals of the connection switching circuit, is formed in a U shape, and
the first parallel switch element and the second parallel switch element are disposed inside the conductive path.

2. The battery according to claim 1, wherein
the conductive path is folded back in a U-shape at the series switch element, and
the series switch element, the first parallel switch element, and the second parallel switch element are arranged in a row.

3. The battery according to claim 1, wherein
the connection switching circuit further includes:
a first current breaker that is a circuit breaker element connected in series with the first parallel switch element, and is provided in parallel with the series circuit of the first battery module and the series switch element together with the first parallel switch element; and
a second current breaker that is a circuit breaker element connected in series with the second parallel switch element, and is provided in parallel with the series circuit of the second battery module and the series switch element together with the second parallel switch element, and
the first current breaker and the second current breaker are disposed inside the conductive path.

4. The battery according to claim 3, wherein
the conductive path is folded back in a U-shape at the series switch element,
the series switch element, the first parallel switch element, and the second parallel switch element are arranged in a row in a first direction, and
the first current breaker and the second current breaker are adjacent to each other in a second direction orthogonal to the first direction, and are disposed between the first parallel switch element and the second parallel switch element in the first direction.

5. The battery according to claim 1, wherein
the first battery module includes a plurality of subsidiary modules connected in series and/or in parallel, and
the second battery module includes a plurality of subsidiary modules connected in series and/or in parallel.
